(19) United States
(12) Patent Application Publication
(10) Pub. No.: US 2004/0049416 A1
(43) Pub. Date: Mar. 11, 2004

(54) System and method for providing survey services via a network

(76) Inventors: David Reese Alison III, Ashburn, VA (US); Bradley E. Davidson, Fairfax, VA (US)

Correspondence Address: Supervisor, Patent Prosecution Services, PIPER RUDNICK LLP, 1200 Nineteenth Street, N.W., Washington, DC, 20036-2412, US

(21) Appl. No.: 10/237,631

(22) Filed: Sep. 10, 2002

(51) Int. Cl. G06F 17/60

(52) U.S. Cl. 705/10

(57) ABSTRACT

A system and method for implementing Web-based surveys, providing application software and hosting services that allow clients to create and send a survey, and review survey results. Each survey response is stored in an XML structure on a server. The XML structure is loosely defined so that once a survey has been published, the underlying structure for the survey can be modified, yet still maintain all of the responses that had been received to date. In one embodiment, the method of providing survey services includes: creating a survey; publishing the survey on a host server; accepting requests for the survey; transmitting surveys to respondents; accepting responses to the survey; storing the responses in an XML structure on the host server; and transmitting the responses to a client.

### BACKGROUND OF THE INVENTION

1. Field of the Invention

The present invention generally relates to providing host services via a network, and more specifically relates to a system and method for providing survey services via a network.

2. Background of the Technology

Current systems and methods exist to handle highly variable survey data. Most survey systems store data in a database where the layout of the tables match the questions in the survey. For example, a client (e.g., a company that wishes to conduct a survey) utilizing a host's survey services creates a survey with the following questions:

Sex: Male or Female

Age: ______

Favorite Activities (select all that apply): Golf Tennis Racquetball Bowling

In this case, in addition to fields that would be required for maintaining survey specific information, the database table must contain a field for each of the options. Thus, there must be a field for each of the following options:

Sex

Age

Activities_Golf

Activities_Tennis

Activities_Racquetball

Activities_Bowling

This situation presents challenges because most survey services only support a small number of columns (e.g., 1024). As a result, many surveys are limited to a relatively small number of questions because multiple-choice questions use one column per option. In addition, if the client decides to change the questions in a survey, the client must redefine the table that the data is stored in, usually resulting in lost data. Furthermore, existing survey services (e.g., Perseus™ survey services, Zoomerang™ survey services) do not have user-friendly interfaces and easily customizable surveys.

### SUMMARY OF THE INVENTION

The present invention implements Web-based surveys, providing application software and hosting services that allow clients to create and send a survey, and review survey results. The survey can be a one-time survey, or part of a collection of surveys.

The present invention solves the above-described limitations by providing an innovative computer-implemented method of storing each survey response in an eXtensible Markup Language (XML) structure on a server. The XML structure is loosely defined so that once a survey has been published, the underlying structure for the survey can be modified, yet still maintain all of the responses that had been received to date.

In one embodiment, the system includes: at least one client terminal, at least one respondent terminal, and a host server (including a main database, a results database, and host application software).

In an embodiment, the method of providing survey services includes the steps of: creating at least one survey; publishing the survey on a host server; accepting at least one request for the survey; transmitting the survey to at least one respondent; accepting at least one response to the survey; storing the at least one response in an XML structure on the host server; and transmitting the at least one response to a client utilizing a client terminal.

Advantages of the present invention include the following: the survey results are stored in a manner that allows the survey to be easily updated and changed, and allows the survey results to be easily accessed; the survey services are user friendly; and the survey services can be customized by the client.

Further features and advantages of the present invention as well as the structure and operation of various embodiments are described in detail below with reference to the accompanying drawings.

### DESCRIPTION OF THE FIGURES

Additional features and advantages of the present invention will become more apparent from the detailed description set forth below when taken in conjunction with the drawings in which like reference numbers indicate identical or functionally similar elements.

FIG. 1 is a pictogram illustrating overview system 100, in accordance with an embodiment of the present invention.

FIG. 2 is a flowchart illustrating overview method 200, in accordance with an embodiment of the present invention.

FIG. 3 is a flowchart illustrating creating the survey process 205, in accordance with an embodiment of the present invention.

FIGS. 4-9 are exemplary screen shots illustrating process 205, in accordance with an embodiment of the present invention.

FIG. 10 is a flowchart illustrating publishing the survey process 210, in accordance with an embodiment of the present invention.

FIGS. 11-12 are exemplary screen shots illustrating process 210, in accordance with an embodiment of the present invention.

FIG. 13 is a flowchart illustrating notifying potential respondents process 215, in accordance with an embodiment of the present invention.

FIGS. 14-20 are exemplary screen shots illustrating process 215, in accordance with an embodiment of the present invention.

FIG. 21 is a flowchart illustrating transmitting the survey process 225, in accordance with an embodiment of the present invention.

FIG. 22 is an exemplary screen shot illustrating process 240, in accordance with an embodiment of the present invention.

FIG. 23A-23H are an exemplary screen shots illustrating process 245, in accordance with an embodiment of the present invention.

### DESCRIPTION OF THE INVENTION

In one embodiment, the present invention implements Web-based surveys, providing application software and hosting services that allow clients to conduct a survey. The survey can be a one-time survey, or part of a collection of surveys. The present invention includes a host, clients, and respondents. The host provides survey services, such as the ability to create a survey or multiple surveys. For example, a client can be a company that wishes to know how many company shareholders are over 60. The client accesses the host's services to create a survey that is customized to the client's needs. Thus, in the example, the client accesses the host's services to create a survey that asks shareholders' ages. The client can then provide email addresses for the shareholders, which the host will use to distribute the survey. The respondents submit survey answers to the host, which makes these results accessible to the client in many user-friendly formats. Thus, for example, the shareholders respond with their ages to the host, who makes the age result information available to the company in a pie graph or other format.

The present invention is described in terms of the above embodiments. This is for convenience only and is not intended to limit that application of the present invention. In fact, after reading the description of the present invention, it will be apparent to one skilled in the relevant arts how to implement the present invention in alternative embodiments.

System Overview

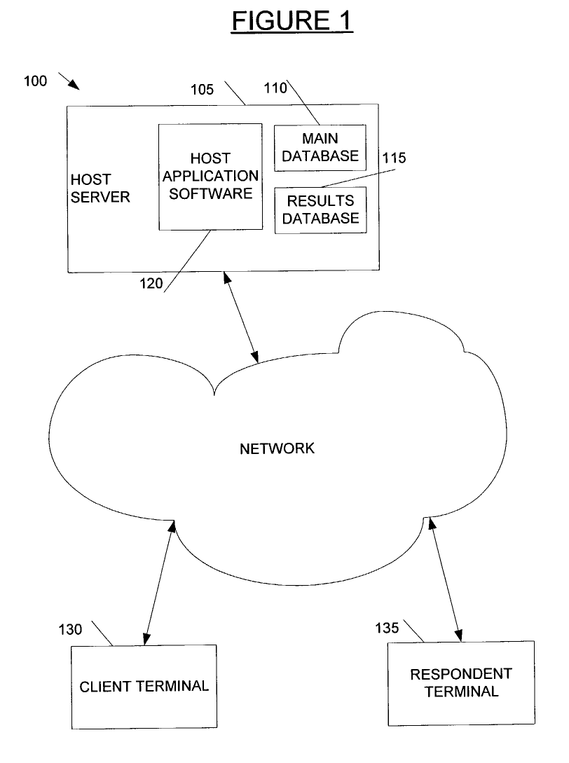

FIG. 1 is a pictogram illustrating overview system 100, in accordance with an embodiment of the present invention. The present invention includes at least one client terminal 130, at least one respondent terminal 135, and a host server 105.

Client Terminal.

The client terminal 130 is a networking device consisting of a video adapter, a monitor, and a keyboard that is used by the client, who creates the survey questions and wishes to review survey responses.

Respondent Terminal.

The host terminal 135 is a networking device consisting of a video adapter, a monitor, and a keyboard that is used by the host, who provides the survey service.

Host Server.

The host server 105 publishes the survey once it has been created. In one embodiment of the present invention, the host server 105 is the host's own production system, for which the client pays a service fee to the host. In another embodiment of the present invention, the client uses the client's own system, for which the client has purchased a license for the host server 105 to install on the client terminal 130. Once the survey is published it is available for respondents to open, in a manner similar to how one opens a Web page on a server. As respondents complete the survey, the response data is collected on the host server 105 and later retrieved for analysis by the host application software 120.

The host server 105 includes a main database 110, a results database 115, and host application software 120.

Main Database.

The main database 110 stores survey account management and information.

Results Database.

The results database 115 stores survey result information. When a survey is published by the host server 105, a new results table is added to the results database 115. In an embodiment, the results tables utilize the following structures:

Submission_Key (Integer).

This is a unique key that is generated when a respondent requests a survey. To determine the submission key the host server 105 retrieves and increments a value from a submission key table, which is used to ensure uniqueness for the key.

Creation_Date (DateTime).

The creation date is used to identify the moment that a respondent first requested a survey.

Submission_Date (DateTime).

The submission date is updated every time a respondent submits answers to a survey.

State (Integer).

The state indicates the current state of the result for that submission key. The state options are: 0= the survey has been requested but no responses received; 1= some answers for the survey have been submitted; 2= the survey has been completed.

Response (Variable Length Text).

The response contains an XML structure for the actual survey answer data. The XML structure contains nodes for the submission key, date/time received and sub-nodes for each of the individual questions within the survey.

XML Structure.

The XML data for the survey response data contains nodes for each of the respondent's answers to the questions asked in the survey. The host application software 120 defines the structure for this data, identifying unique IDs that maintain the integrity of the results. In the event that the client changes the survey structure after the survey has been published, all data collected before that point is still maintained.

Host Application Software.

The survey is stored as an XML structure that defines the various questions in the survey, introductory and closing text for the survey, formatting commands, validation, etc.

The client creates this XML object with the host application software 120. The XML structure contains a variable length list of each question and its associated properties. When the survey is published to the host server 105, the XML data is transferred to the host server 105. When a respondent requests a survey the host server 105 opens the XML structure, reads the various definitions, identifies if an existing response has been created and then renders the appropriate page to the respondent.

The host application software 120 creates and publishes surveys, notifies potential respondents about the surveys, and analyzes the survey results. Clients download a copy of the host application software 120 onto the client terminal 130 in order to create their own customized surveys. A series of templates offer clients the ability to create surveys very quickly. Alternatively, the client can simply enter the desired survey questions.

Method Overview

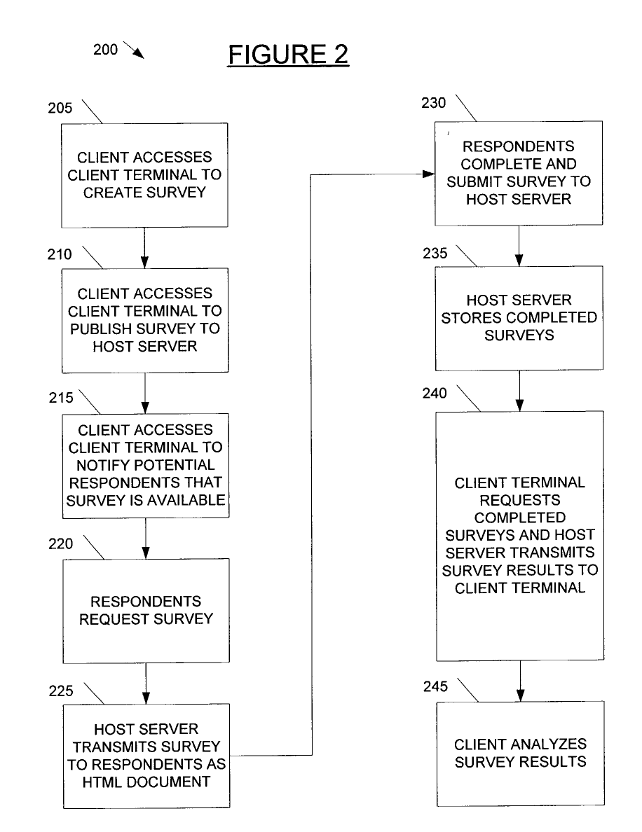

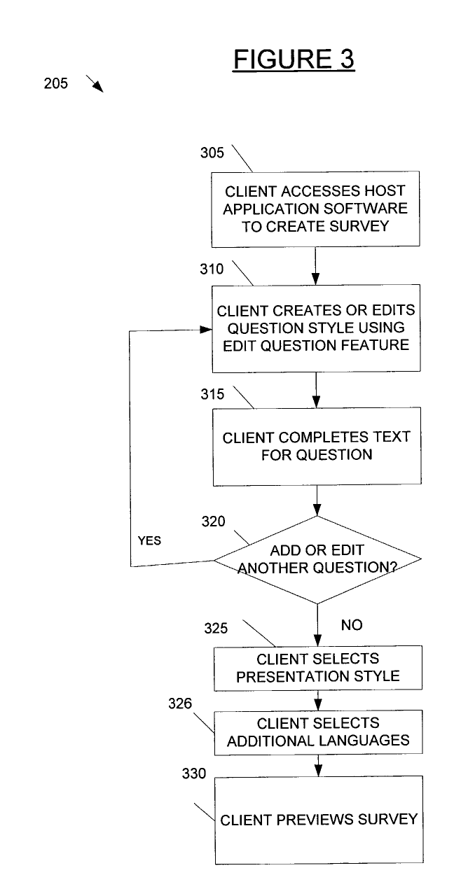

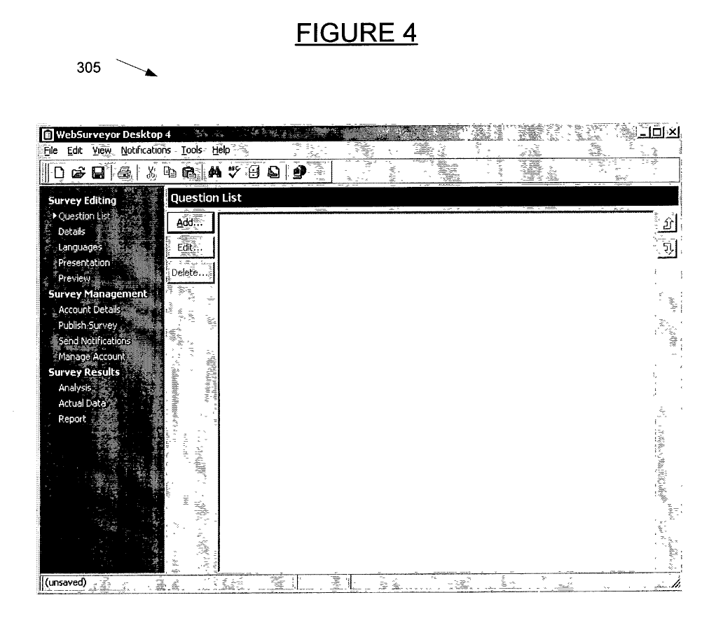

FIG. 2 is a flowchart illustrating overview method 200, in accordance with an embodiment of the present invention. In step 205, the client accesses the client terminal 130 to create a survey, using the host application software 120. Details of process 205 are shown in FIG. 3, and exemplary screen shots illustrating process 205 are shown in FIGS. 4-9, as described below.

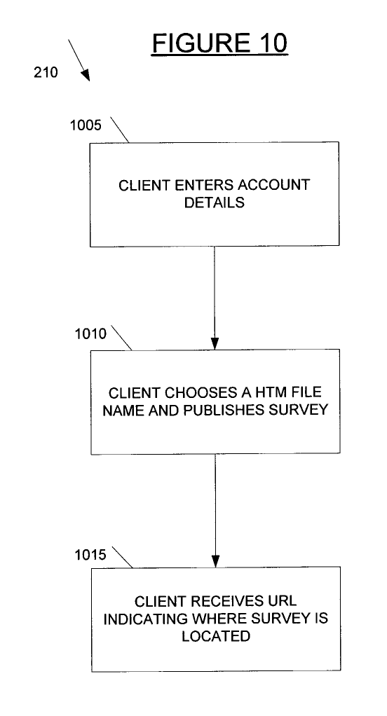

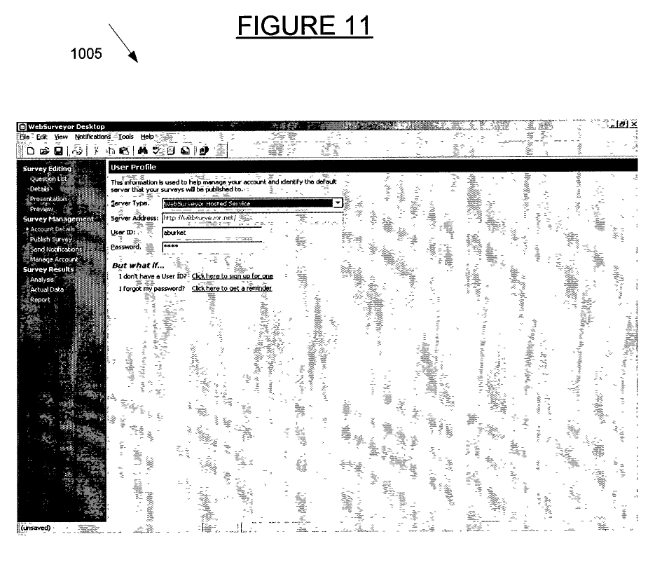

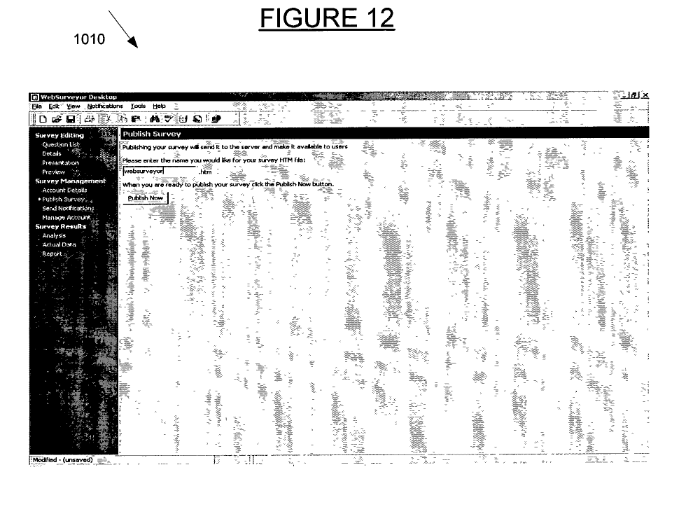

In step 210, the client accesses the client terminal 130 to publish the survey to the host server 105. Details of process 210 are shown in FIG. 10, and exemplary screen shots illustrating process 210 are shown in FIGS. 11-12, as described below.

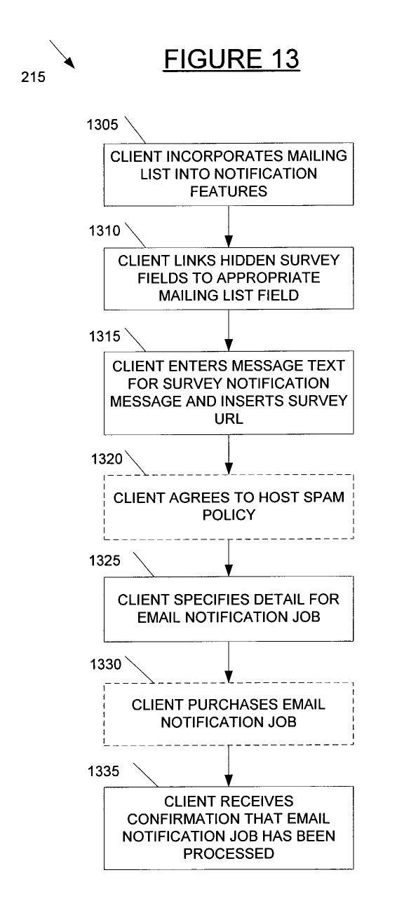

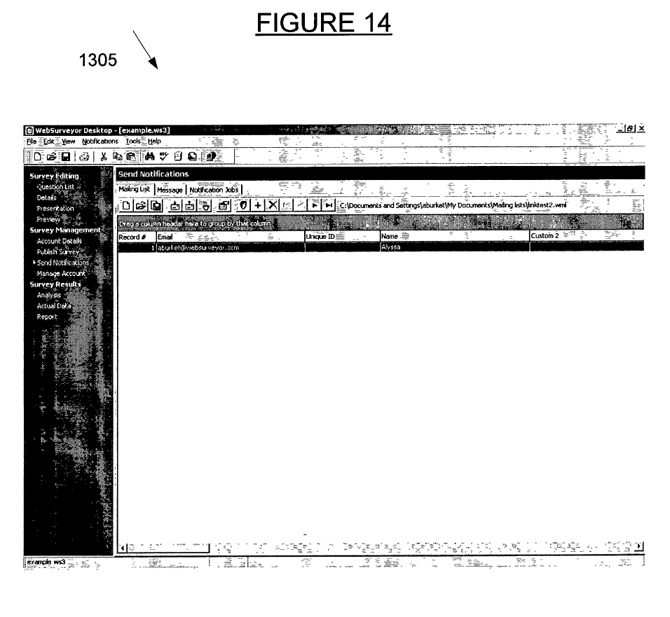

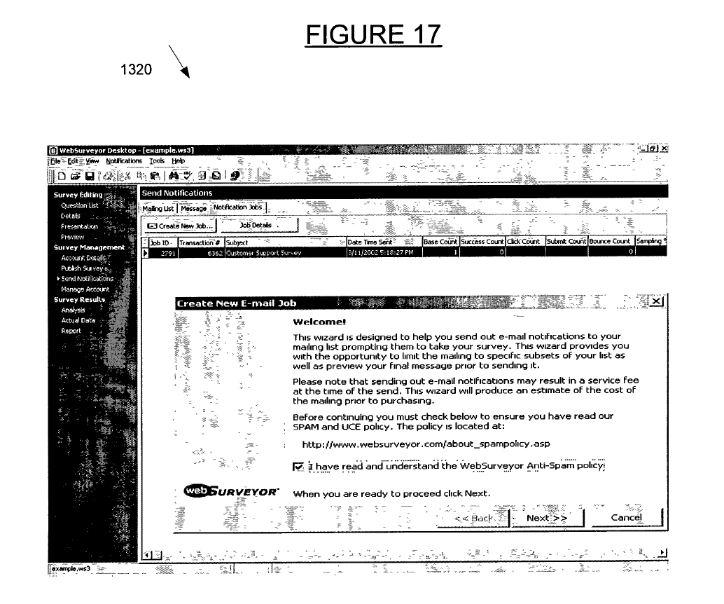

In step 215, the client accesses the client terminal 130 to notify potential respondents that the survey is available. In one embodiment, the client terminal 130 transmits email to potential respondents requesting that they complete the survey and providing a link to the survey in the body of the email. Details of this embodiment of process 215 are shown in FIG. 13, and exemplary screen shots illustrating this embodiment of process 215 are shown in FIGS. 14-20, as described below. In another embodiment, the client posts the survey via a link on the client's Web site.

In step 220, the respondents access the survey. In one embodiment, the respondents access the survey via a link in an email request. In another embodiment, the respondents access the survey via a link on the client's Web site.

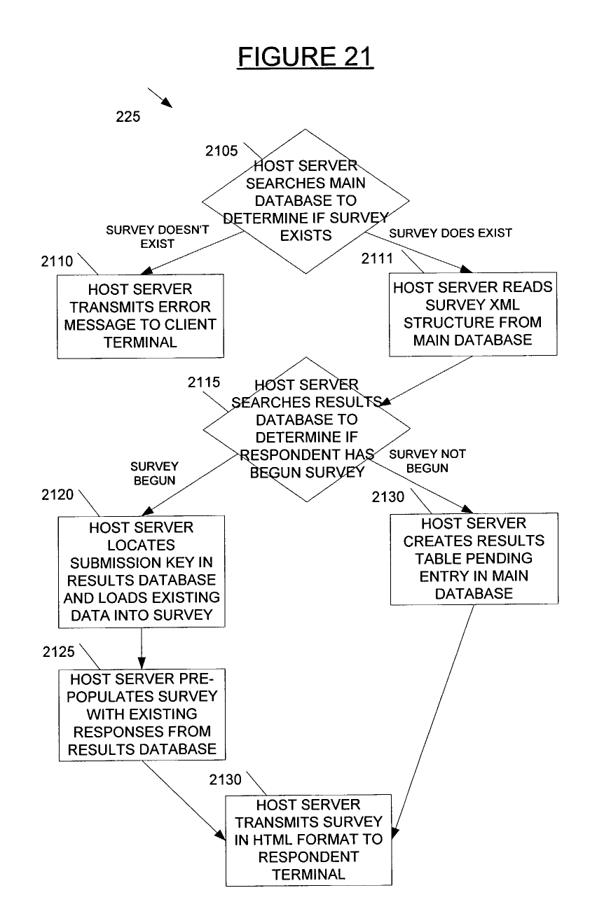

In step 225, the host server 105 transmits the survey to the respondents as a hypertext Markup Language (HTML) document. Details of process 225 are shown in FIG. 21. In step 230, the respondents complete and submit the survey to the host server 105. In step 235, the host server 105 accepts and stores the completed surveys.

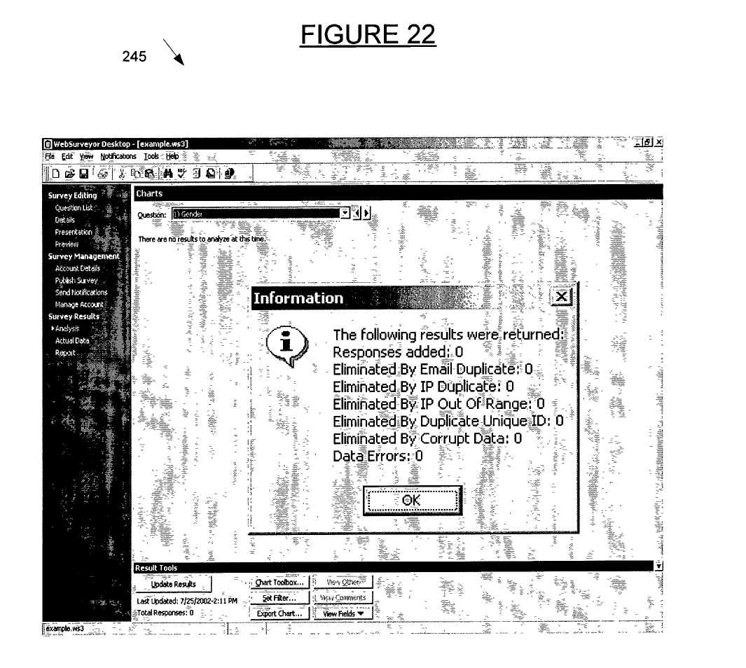

In step 240, the client terminal 130 requests the completed surveys and the host server 105 transmits all completed surveys to the client terminal 130. The client also receives information including, but not limited to: responses added; responses eliminated by email duplication; responses eliminated by duplication; responses eliminated because they are out of range; responses eliminated by duplicate unique ID; responses eliminated by corrupt data; and data errors. An exemplary screen shot illustrating process 240 is shown in FIG. 22.

In step 245, the client analyzes the results via charts, filters, and cross-tabulations. For example, the client can view the total number of surveys, and the number of different survey answers illustrated by different colors in a pie chart. In addition, the client can update results, format the output of the survey results using a chart toolbox (e.g., choose a bar chart instead of a pie chart), filter the survey results, export a chart of survey results, view another form of the survey results (e.g., change a chart into a graph, or look at a specific piece of a chart), view comments by survey responders, and view the XML fields of the survey responses in code format.

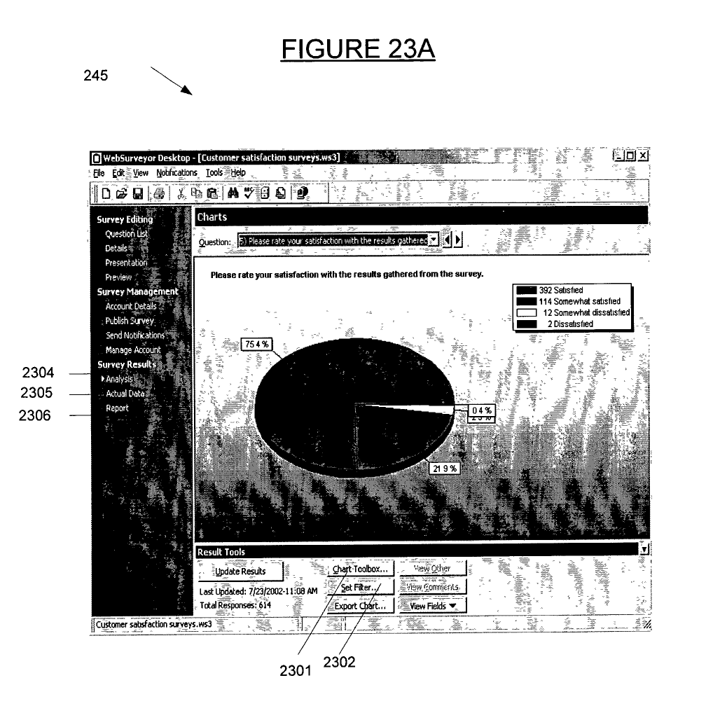

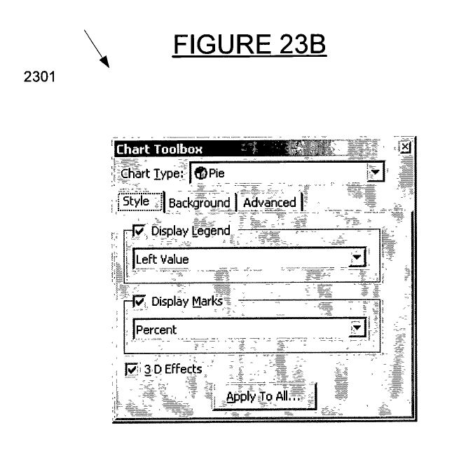

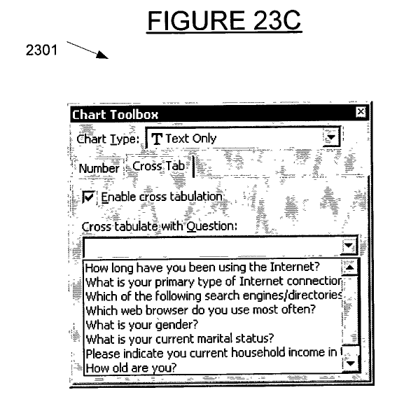

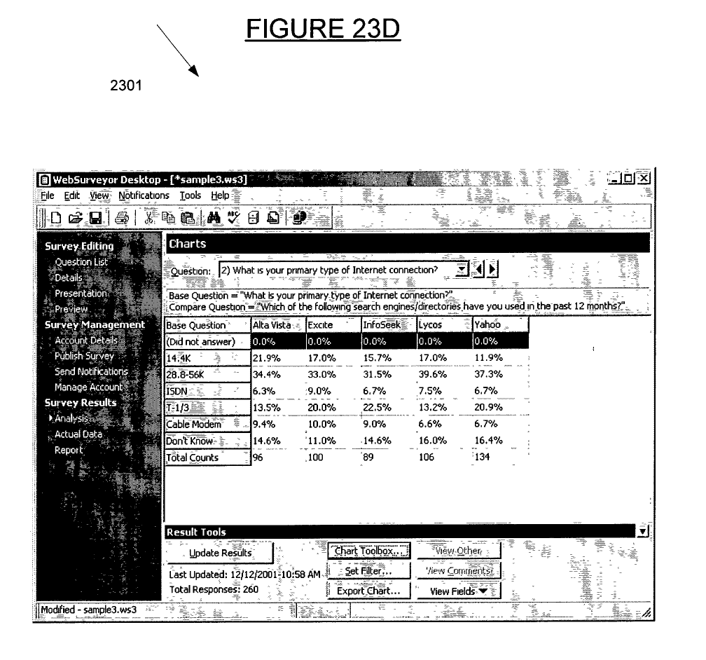

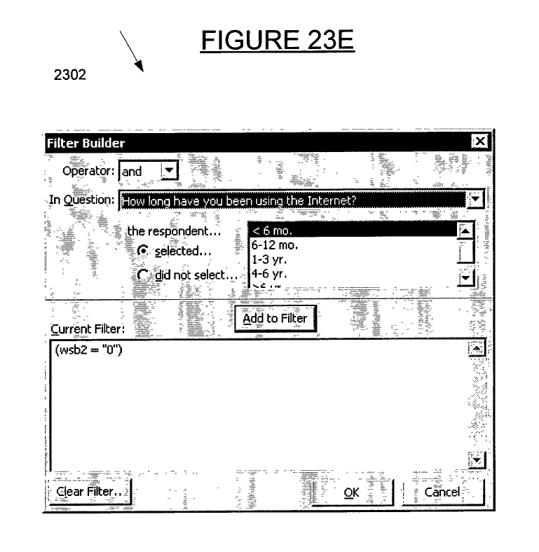

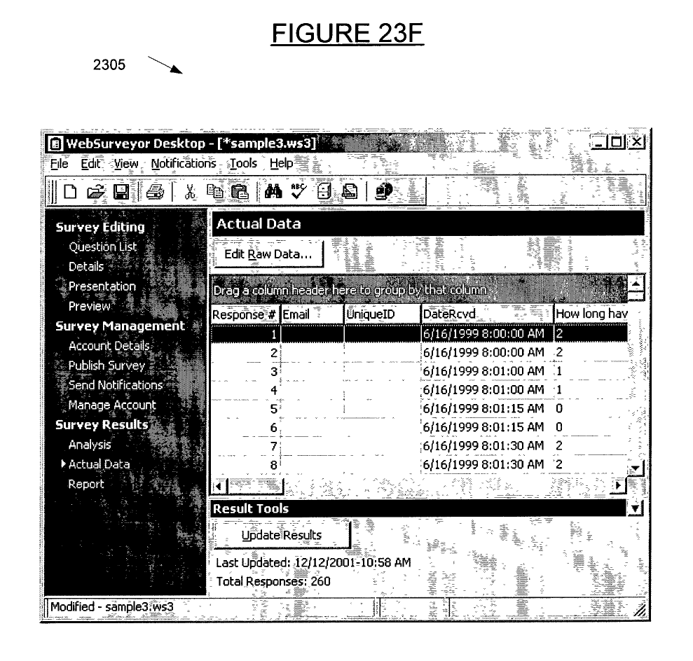

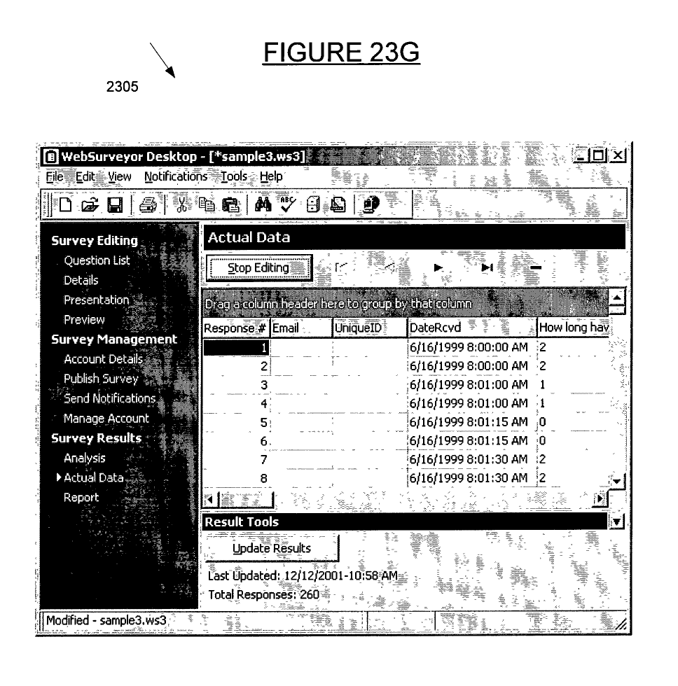

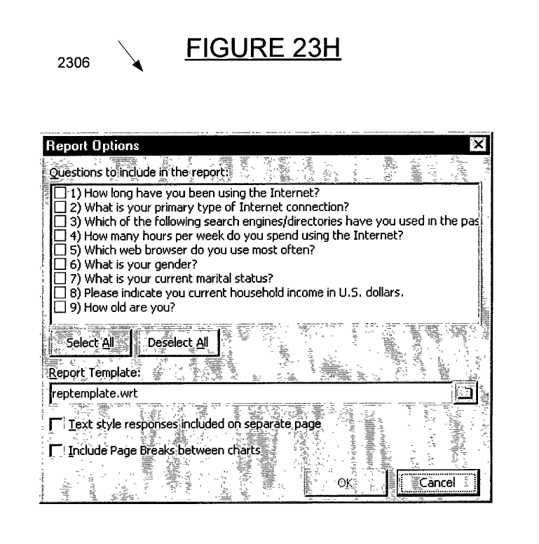

An exemplary screen shot illustrating process 245 is shown in FIGS. 23A-23H, according to an embodiment of the present invention. FIG. 23A illustrates the analysis options 2304 that allow the client to analyze the survey results. Actual data option 2305 features are shown in FIGS. 23F-23G, and report option 2306 features are shown in FIG. 23H.

Referring to FIG. 23A, the client can navigate through each of the questions in the survey and see the results for that question. Results can be updated with recent responses while the client is viewing current responses. The client can access a chart toolbox 2301 to control the appearance of the graphics used to display the results. FIGS. 23B-23D illustrate some features of the chart toolbox 2301. The client can access a set filter option 2302 to filter the information that appears in the results set. FIG. 23E illustrates features of the set filter option 2302. The client can access the export chart option 2303 to send the chart to another entity. The client can also view other responses that respondents put in “other” fields, or view comments that respondents put in “comment” fields. A view fields option allows the client to display when the actual responses were received, and email addresses of respondents. A result tool allows the client to change the perspective and presentation of the charts.

FIG. 3 is a flowchart illustrating creating the survey process 205, in accordance with an embodiment of the present invention. In step 305, the client accesses the host application software 120, allowing creation of a survey. The client has the option of creating at least one question, indicating question details, choosing survey languages, choosing a survey presentation, and previewing the survey. An exemplary screen shot illustrating process 305 is shown in FIG. 4.

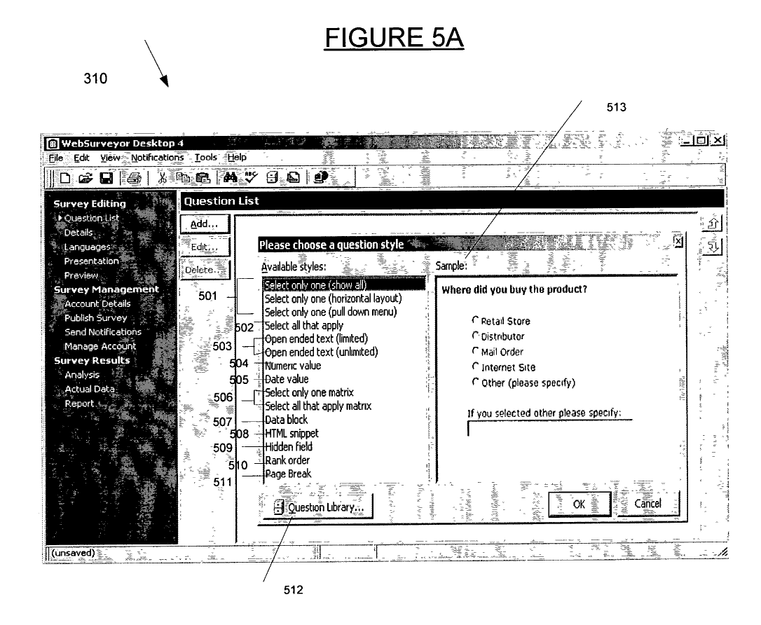

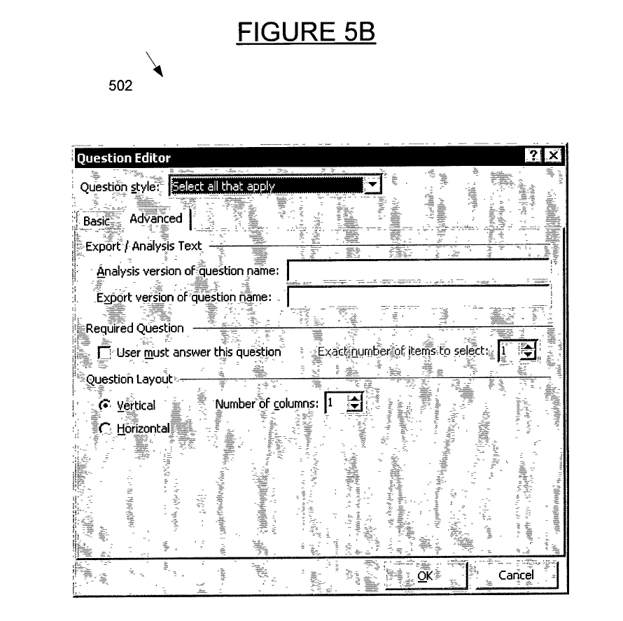

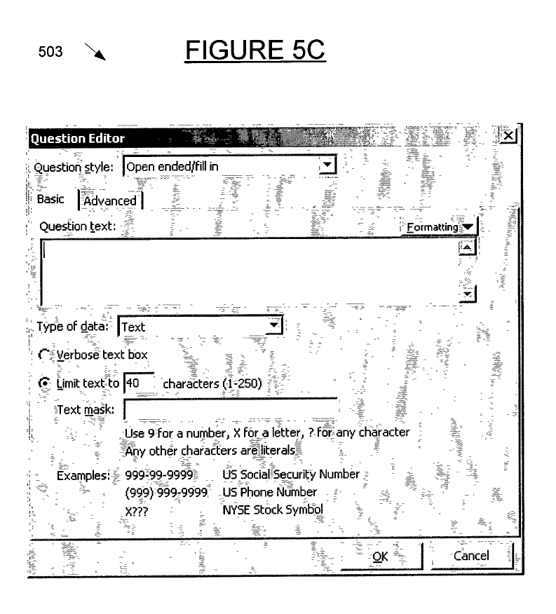

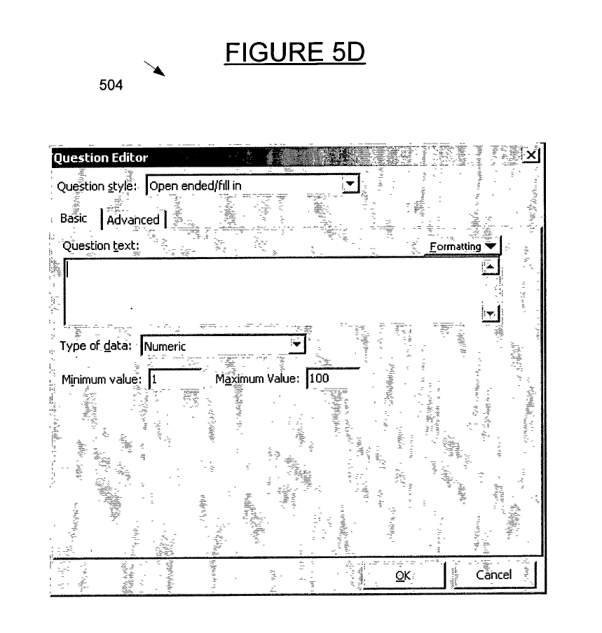

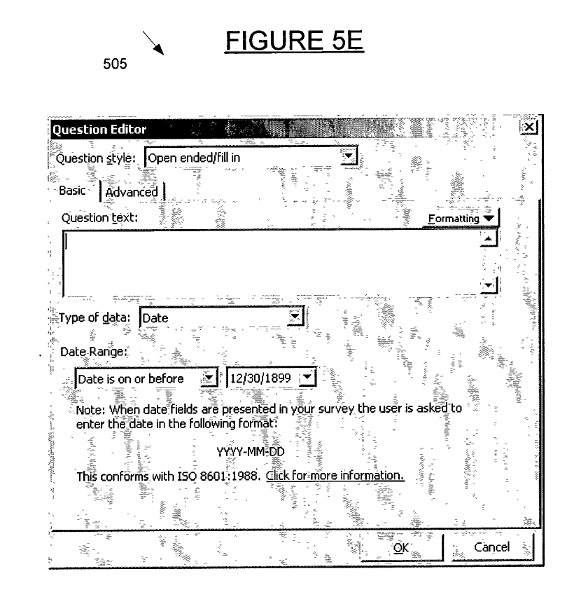

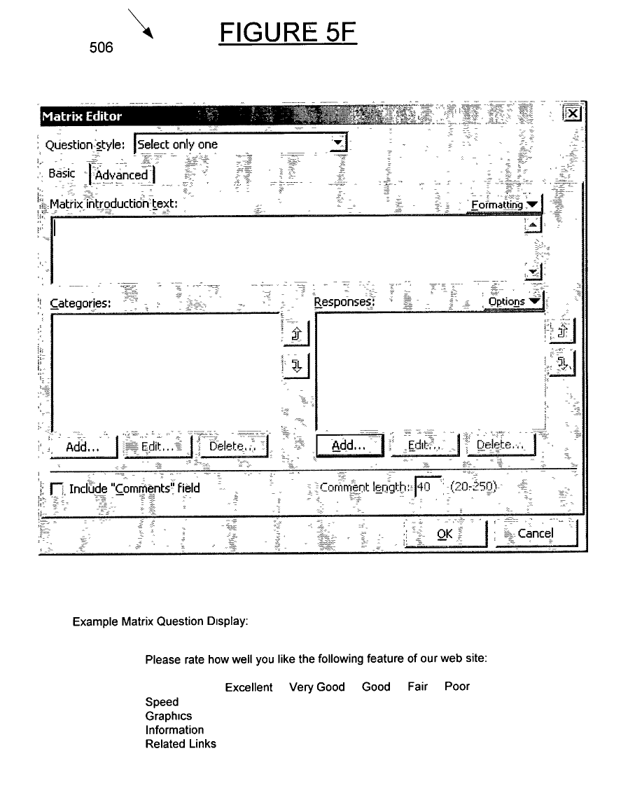

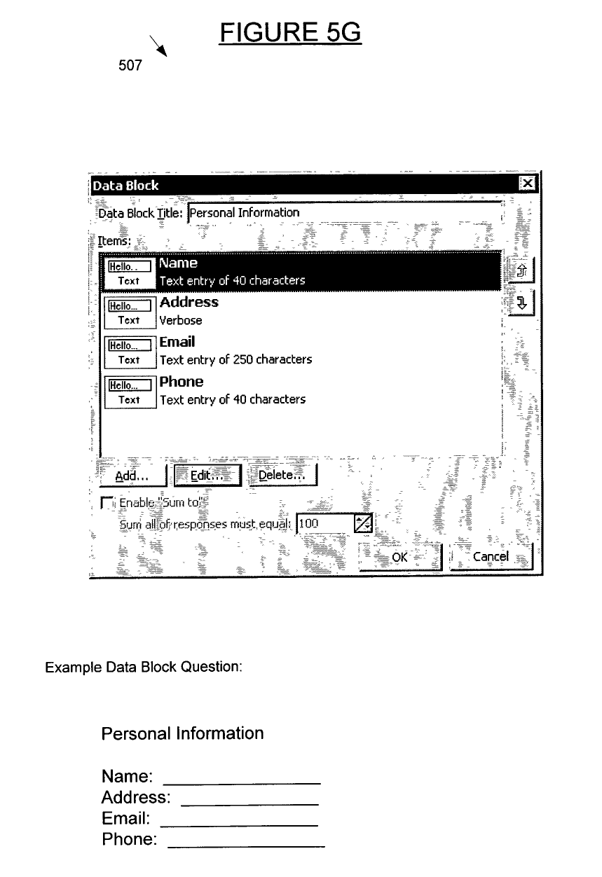

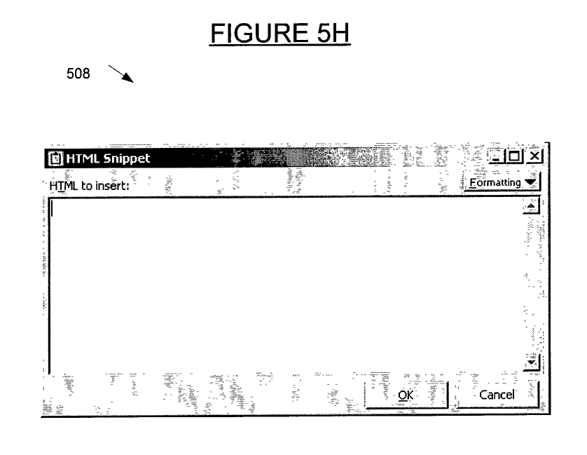

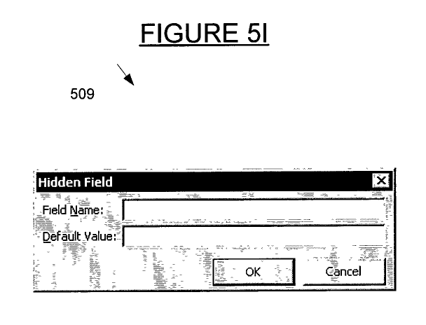

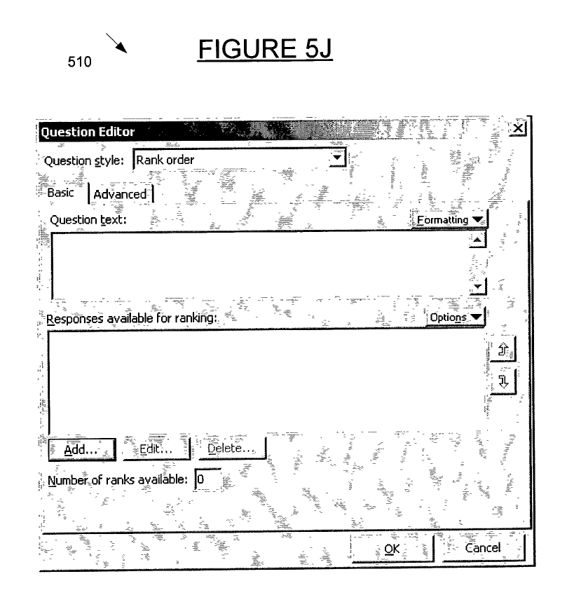

In step 310, the client creates or edits a question by choosing an available question style. An exemplary screen shot illustrating process 310 is shown in FIG. 5A. The available question styles include, but are not limited to, select only one 501 (e.g., show all, horizontal layout, pull down menu), select all that apply 502, open ended text 503 (e.g., limited, unlimited), numeric value 504, data value 505, matrix 506 (e.g., select only one, select all that apply), data block 507, HTML snippet 508, hidden field 509 (e.g., to incorporate data such as a name or customer ID into the survey without requiring the respondent to enter it), rank order 510, and page break 511. Exemplary screen shots illustrating how a client enters these various question styles are shown in FIGS. 5A-5K. A sample window 513 of each question style is displayed. The client also has the option of accessing a question library 512 containing numerous pre-defined sample questions. These pre-defined questions can be used or modified to fit the client's specific needs. A number of topic libraries are available in the question library (e.g., human resource, marketing, training) and questions can be mixed and matched from different libraries. In addition, the client can create a client-specific library.

In step 315, the client completes the text for the question, using the question style chosen in step 310. The client completes the question text and the answer text, with the option for a basic or advanced question text. The basic option allows the client to write the question text. The advanced option, among other features, allows the client to control how the question will be displayed. The client can add, edit, or delete question or answer text. In addition, other text response or comments can be included. For example, if a question asked the respondent to identify their vehicle make, the question would have a list of vehicle manufacturers, and then an “other” or “comment” field for the respondent to fill in if the respondent's vehicle manufacturer was not listed.

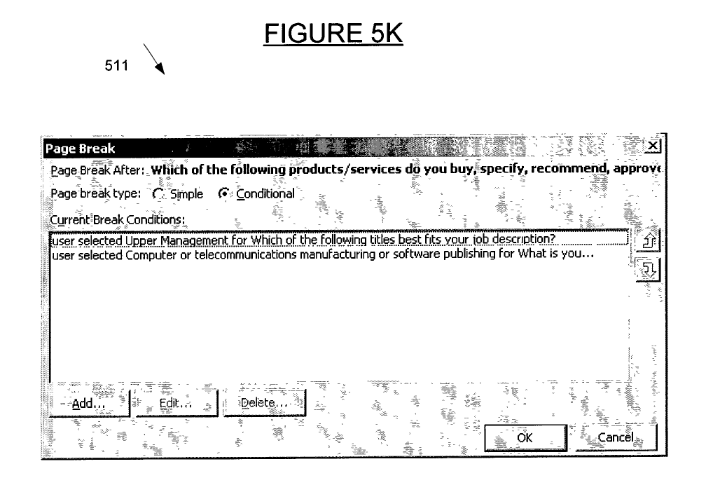

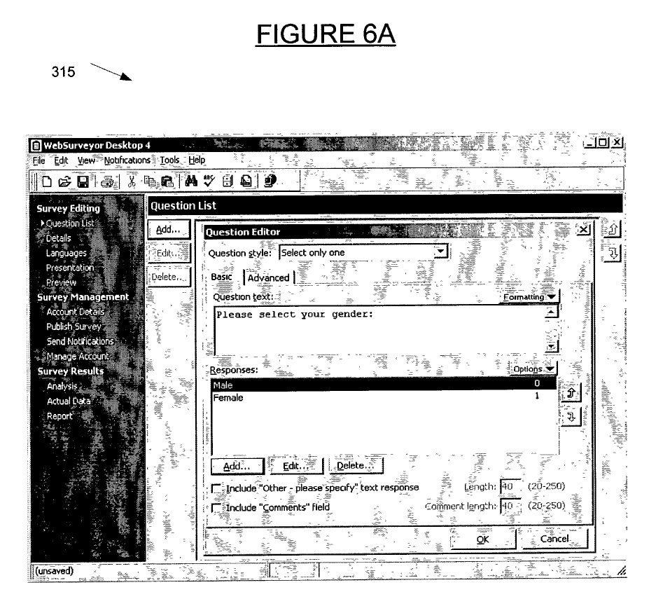

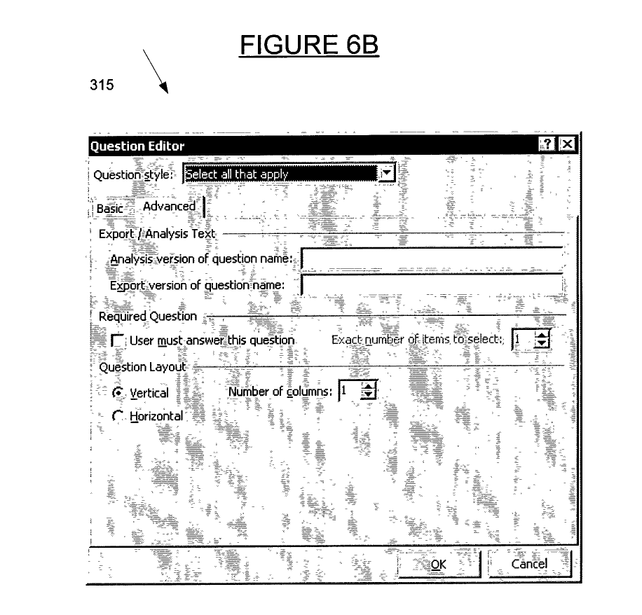

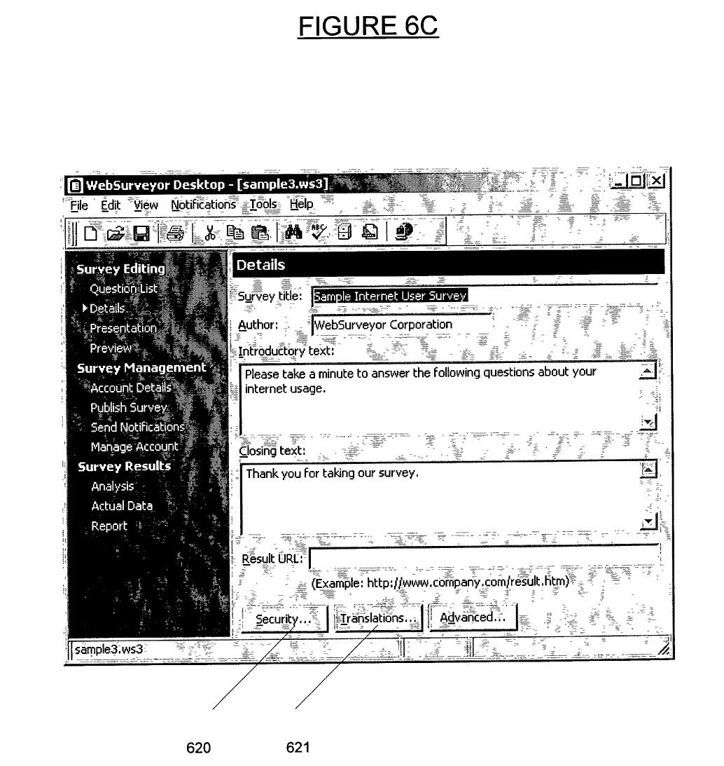

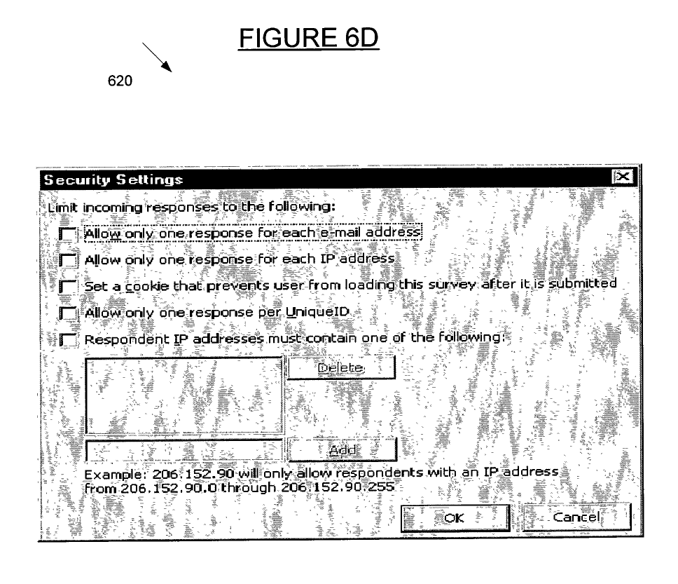

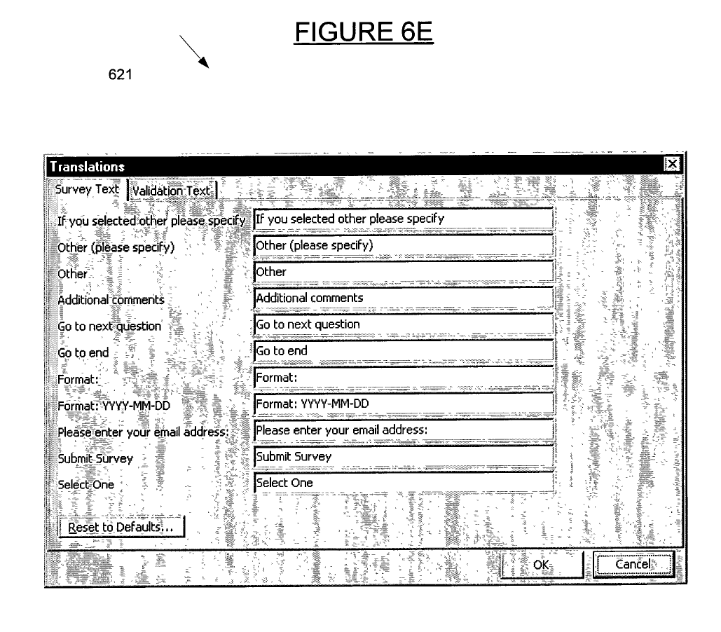

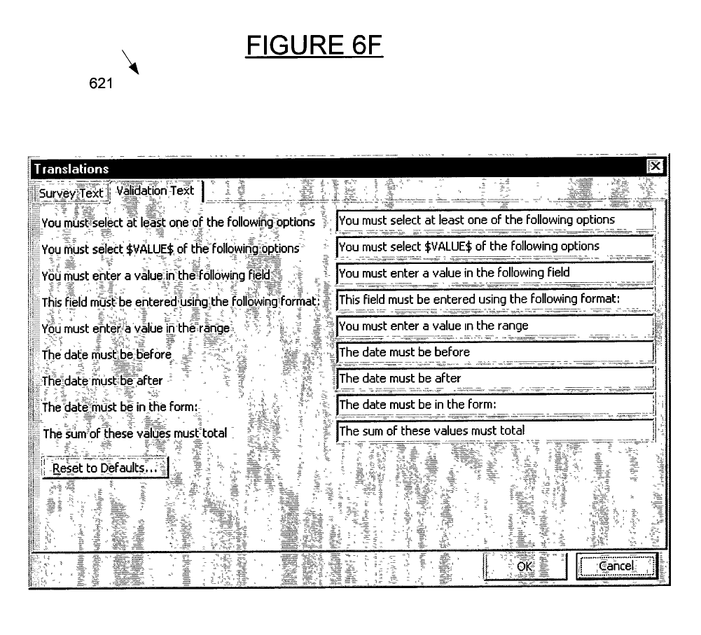

A screen shot illustrating process 315 is shown in FIGS. 6A-6B, according to an embodiment of the present invention. FIG. 6A illustrates the basic option, which allows the client to create a question, including, but not limited to, question text, responses, other (e.g., for respondent answers that are not listed in the response section), and a respondent comment section. If an open ended question style is used, the client has the option of choosing a data type (e.g., text, numeric, date). FIG. 6B illustrates the advanced option, which allows the client to designate export analysis text (e.g., a nickname for the question), whether the question is required, and a question layout style (e.g., vertical, horizontal).

In an embodiment of the present invention, the client also has the option to designate survey details, such as security or translation details. FIGS. 6C-6F illustrates survey details, in accordance with an embodiment of the present invention. Referring to FIG. 6C, survey details include, but are not limited to, survey title, author, introductory text, closing text, result URL, security options 620, translation options 621, and advanced details. FIG. 6D illustrates security options 620 (e.g., allowing only one response for each email address, allowing only one response for each IP address, setting a cookie that prevents the respondent from loading this survey after it is submitted, allowing only one response per unique ID), according to an embodiment of the present invention. FIGS. 6E and 6F illustrate translation options 621, according to an embodiment of the present invention.

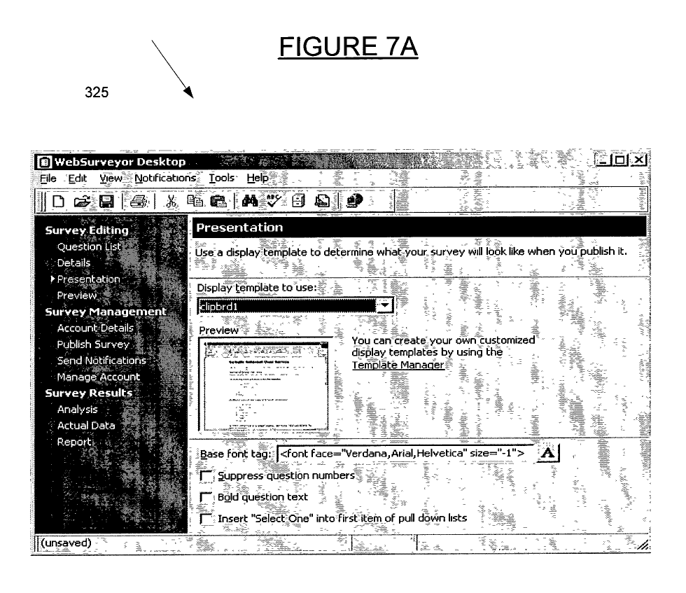

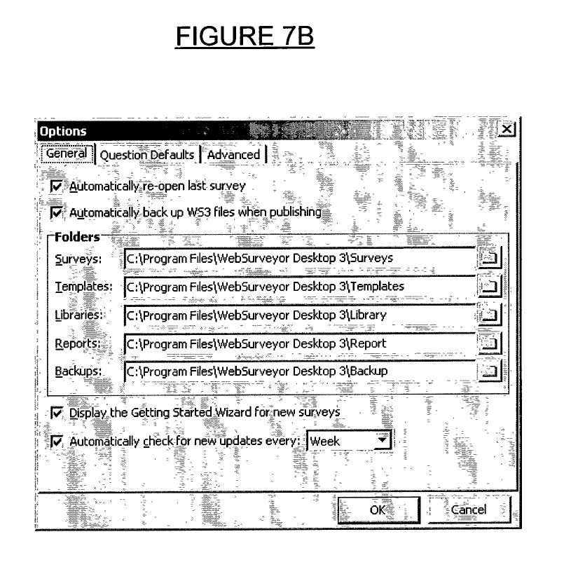

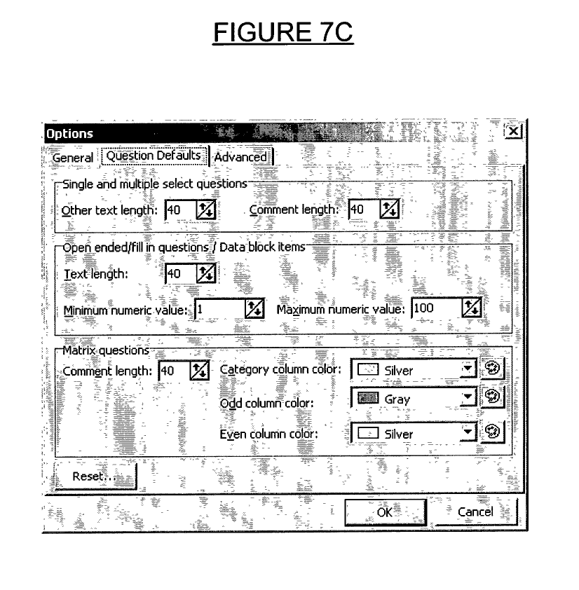

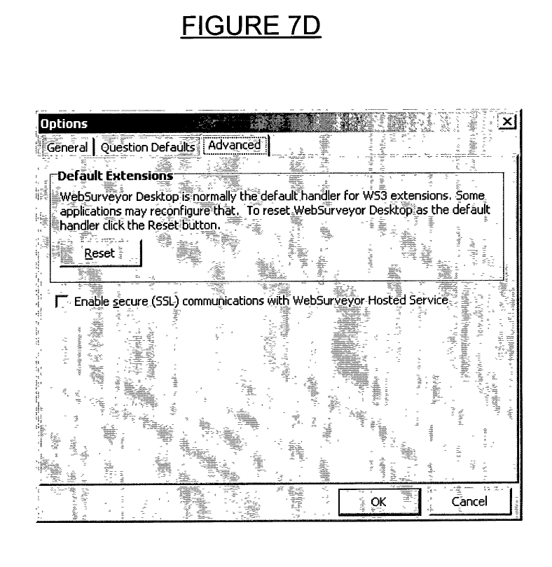

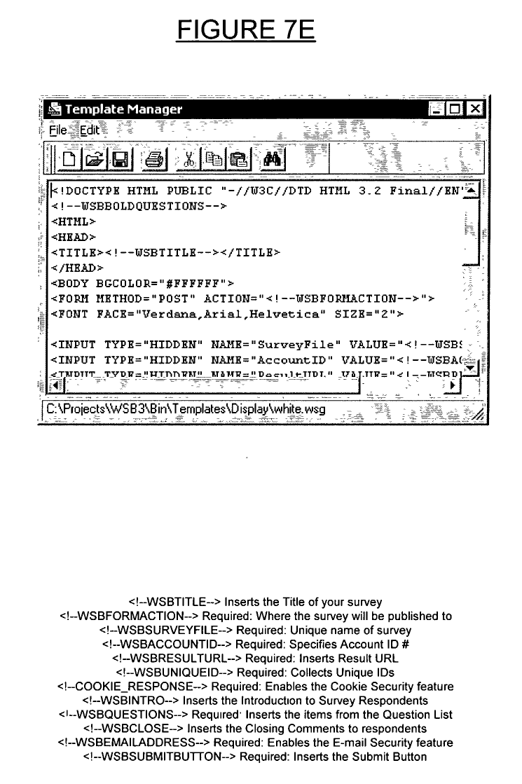

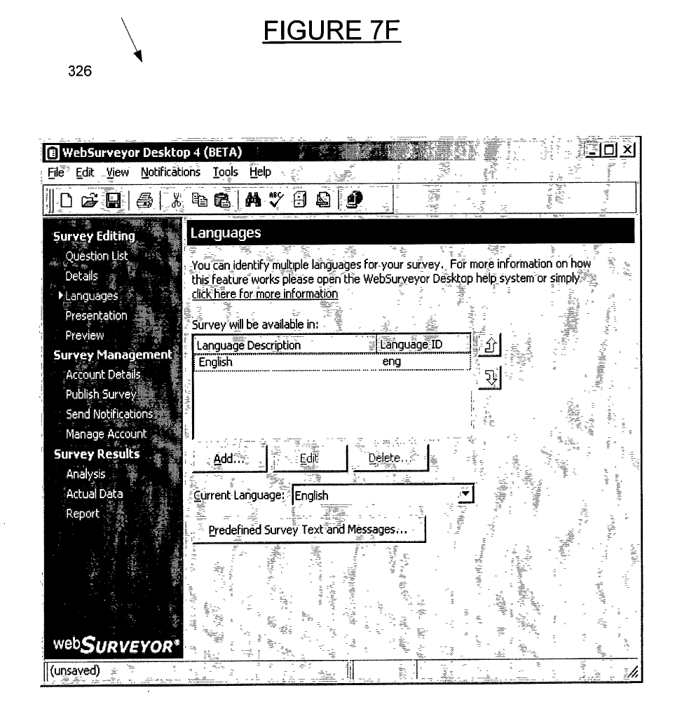

In step 320, the client decides whether to create another question. If yes, the process returns to step 310 and repeats steps 310-320. If no, the process moves to step 325, where the client chooses or edits a chosen survey presentation style. The client uses a display template to determine how the survey will appear when it is published. The client also has the option to eliminate question numbers, bold questions, and/or insert “select one” into the first item of pull down lists. The client chooses from numerous templates that are displayed. In addition, the client can create a customized display template by using a template manager. The client may also choose other options, including, but not limited to: a font; whether to suppress questions; whether to bold question text; and whether to insert “select one” into the first item of pull down lists. A screen shot illustrating process 325 is shown in FIG. 7A, in accordance with an embodiment of the present invention.

In an embodiment of the present invention, the client may designate application options. FIGS. 7B-7D illustrate application options, according to an embodiment of the present invention. FIG. 7B illustrates general options (e.g., automatically re-open last survey, automatically back up WS3 files when publishing), FIG. 7C illustrates question defaults (e.g., text length, minimum and maximum values), and FIG. 7D illustrates advanced options (e.g., default extensions, enable secure).

In step 326, the user has the option of identifying additional languages that the survey would support. As new languages are added they can be selected by clicking on a current language pull down list. Once a new language is selected, the user can return to the questions list (repeating steps 310-325) until all questions re translated into the new language. An exemplary screen shot illustrating process 326 is shown in FIG. 7F.

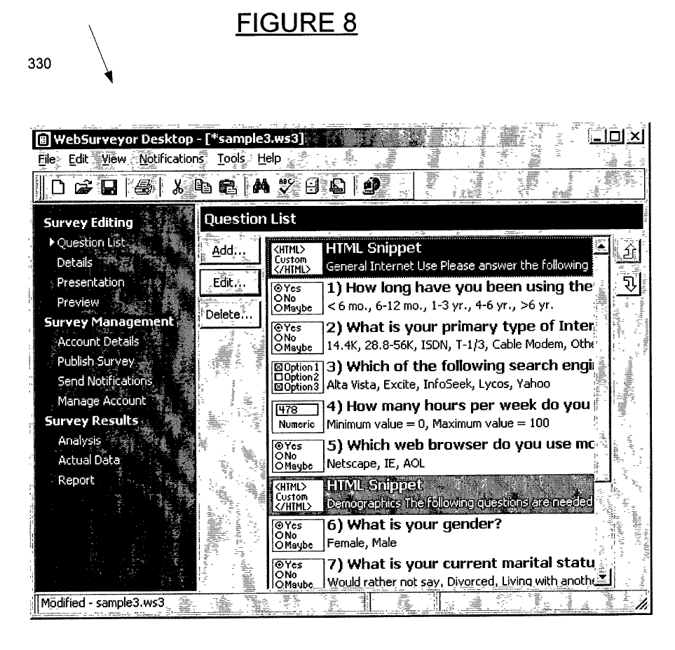

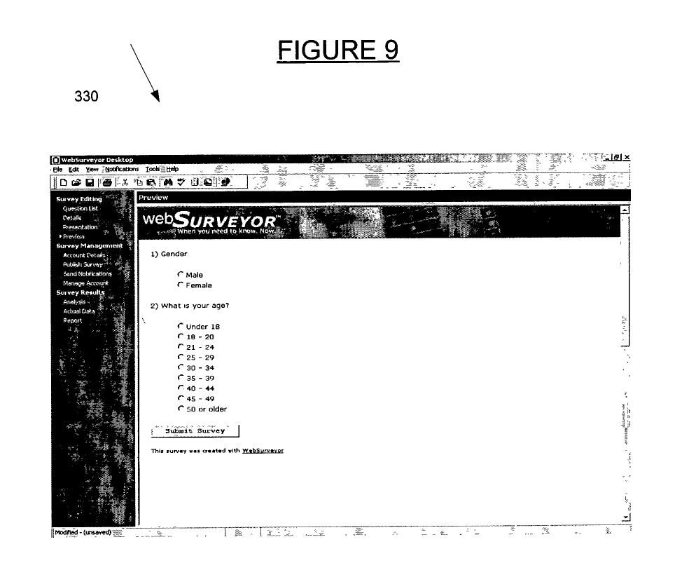

In step 330, the client previews the survey. The client has the option to view the question list, rearrange the question order, view internal IDs, add a question, or view the survey the way it will appear online to respondents. Exemplary screen shots illustrating process 330 are shown in FIGS. 8-9.

FIG. 10 is a flowchart illustrating publishing the survey process 210, in accordance with an embodiment of the present invention. In step 1005, the client reviews account details, including, but not limited to: server type; server address; user ID; and password information. If the respondent does not have a user ID or does not remember their password, help can be sought. An exemplary screen shot illustrating process 1005 is shown in FIG. 11. In step 1010, the client selects a .htm file name to represent the survey, and indicates that the survey is ready to be published by the host. An exemplary screen shot illustrating process 1010 is shown in FIG. 12. In step 1015, the client receives a URL indicating where the survey is located and viewed with a browser.

FIG. 13 is a flowchart illustrating notifying potential respondents process 215, in accordance with an embodiment of the present invention. In step 1305, the client incorporates email list information into the email notification job feature. Thus, for example, the client enters email addresses for all the potential respondents that will receive the survey. An exemplary screen shot illustrating process 1305 is shown in FIG. 14.

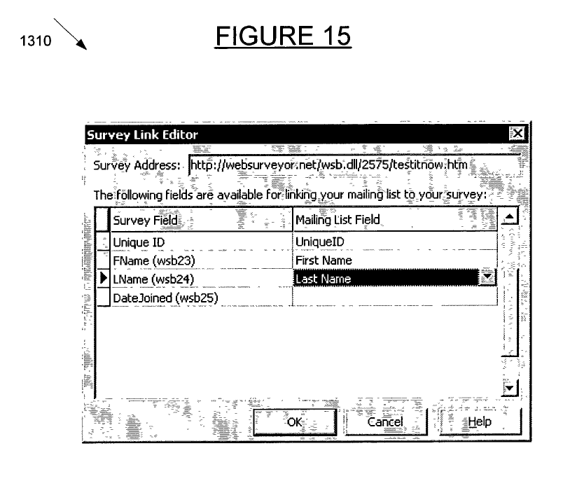

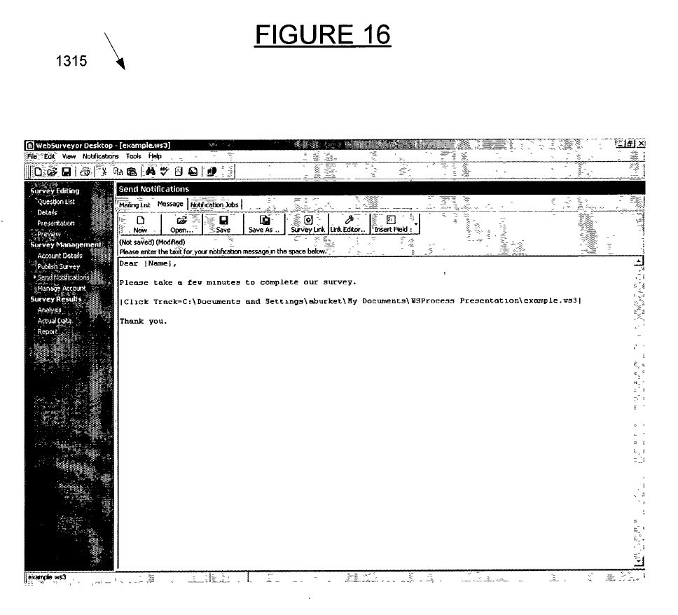

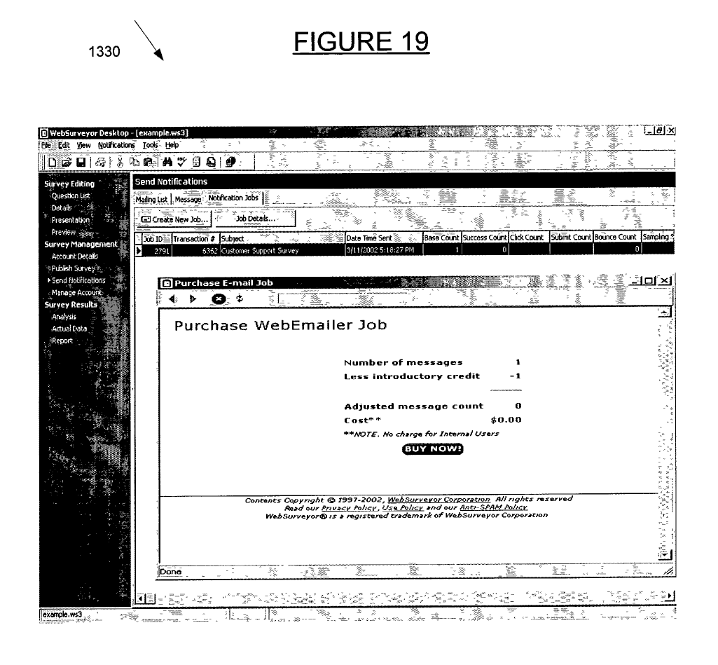

In step 1310, the client links hidden survey fields to appropriate email list fields. Thus, for example, a client can create hidden fields for a first and last name and link these fields to the email fields for first and last name. A screen shot illustrating process 1310 is shown in FIG. 15, according to an embodiment of the present invention. In step 1315, the client enters the message to potential respondents that will accompany the survey, and the survey link. An exemplary screen shot illustrating process 1315 is shown in FIG. 16. In optional step 1320, the client agrees to a host policy governing spam (i.e., unsolicited email messages) sent to respondents. An exemplary screen shot illustrating process 1320 is shown in FIG. 19.

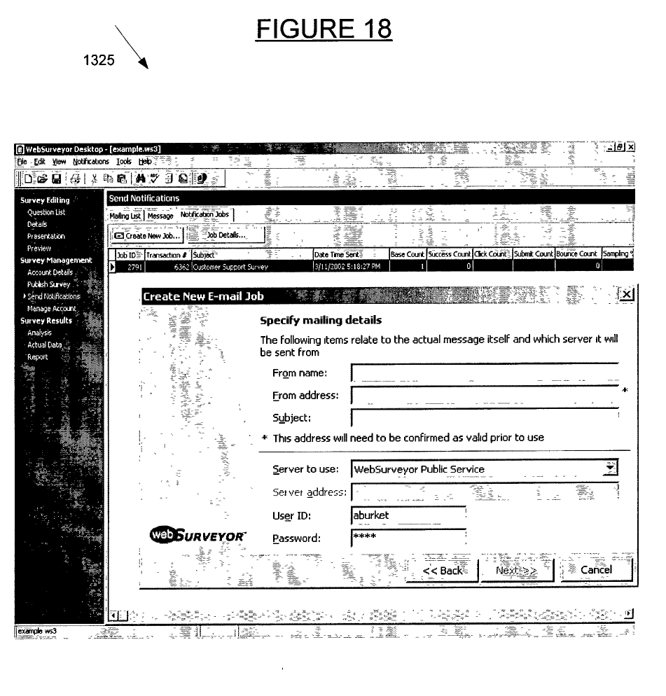

In step 1325, the client specifies details for the email notification job, including, but not limited to: from name; from address; subject; server to use; server address; user ID; and password. An exemplary screen shot illustrating process 1325 is shown in FIG. 18.

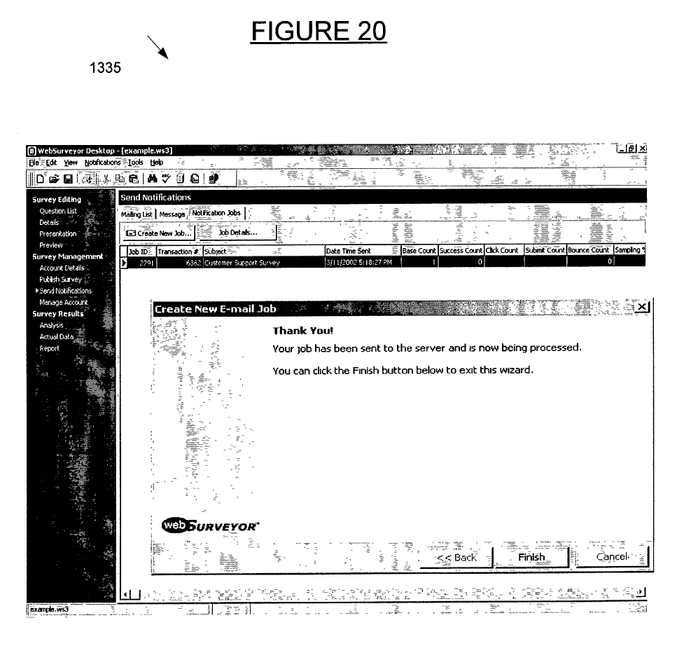

In step 1330, the client provides purchase information and purchases the email notification job. An exemplary screen shot illustrating process 1330 is shown in FIG. 19. In step 1335, the client receives confirmation that the email notification job is being processed. An exemplary screen shot illustrating process 1335 is shown in FIG. 20.

FIG. 21 is a flowchart illustrating transmitting the survey process 225, in accordance with an embodiment of the present invention. In step 2105, the host server 105 searches the main database 110 to determine if the requested survey exits. If no, the requested survey does not exist, the process 225 moves to step 2110 where the host server 105 transmits an error message that is displayed on the client terminal 130. If yes, the requested survey does exist, the host server 105 reads the survey XLM structure from the main database 110, as shown in step 2111.

In step 2115, the host server 105 searches the results database 115 to determine if the respondent has already begun the survey. If yes, in step 2120 the respondent has already begun, the host server 105 locates a submission key in the results database 115 and loads existing data from the results database 115 into the survey. In step 2125, the host surver pre-populates the survey with existing client responses from the results database 115.

If no, the respondent has not already begun the survey, the host server 105 creates a new results table entry as a pending entry in the main database 110, as shown in step 2130. In step 2135, the host server 105 transmits the survey to the respondent in an HTML format.

Example Implementations

The present invention (i.e., the system 100 and any parts or functions thereof) may be implemented using hardware, software or a combination thereof and may be implemented in one or more computer systems or other processing systems. In fact, in one embodiment, the invention is directed toward one or more computer systems capable of carrying out the functionality described herein. An example of a computer system includes one or more processors. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

The computer system can include a display interface that forwards graphics, text, and other data from the communication infrastructure (or from a frame buffer not shown) for display on the display unit.

The computer system can also include a main memory, preferably random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well known manner. The removable storage unit represents a floppy disk, magnetic tape, optical disk, etc. which is read by and written to by the removable storage drive. As will be appreciated, the removable storage unit includes a computer usable storage medium having stored therein computer software and/or data.

In alternative embodiments, the secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to the computer system.

The computer system may also include a communications interface, which allows software and data to be transferred between the computer system and external devices. Examples of the communications interface may include a modem, a network interface (such as an Ethernet card), a communications port, a Personal Computer Memory Card International Association (PCMCIA) slot and card, etc. Software and data transferred via the communications interface are in the form of signals which may be electronic, electromagnetic, optical or other signals capable of being received by the communications interface. These signals are provided to the communications interface via a communications path (e.g., channel). This channel carries signals and may be implemented using wire or cable, fiber optics, a telephone line, a cellular link, an radio frequency (RF) link and other communications channels.

In this document, the terms “computer program medium” and “computer usable medium” are used to generally refer to media such as a removable storage drive, a hard disk installed in hard disk drive, and signals. These computer program products provide software to the computer system. The invention is directed to such computer program products.

Computer programs (also referred to as computer control logic) are stored in a main memory and/or secondary memory. Computer programs may also be received via the communications interface. Such computer programs, when executed, enable the computer system to perform the features of the present invention, as discussed herein. In particular, the computer programs, when executed, enable the processor to perform the features of the present invention. Accordingly, such computer programs represent controllers of the computer system.

In an embodiment where the invention is implemented using software, the software may be stored in a computer program product and loaded into the computer system using a removable storage drive, a hard drive or a communications interface. The control logic (software), when executed by the processor, causes the processor to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

Conclusion

The present invention is described in terms of the above embodiments. This is for convenience only and is not intended to limit the application of the present invention. In fact, after reading the description of the present invention, it will be apparent to one skilled in the relevant arts how to implement the present invention in alternative embodiments.

In addition, it should be understood that FIGS. 1-23 described above, which highlight the functionality and advantages of the present invention, are presented for example purposes only. The architecture of the present invention is sufficiently flexible and configurable, such that it may be utilized in ways other than that shown in FIGS. 1-23.

What is claimed is:

1. A computer-implemented method for providing survey services over a network, comprising:
transmitting a survey from an associated survey results table stored on a host server to at least one respondent who accesses the survey via a respondent terminal via the network;
accepting an input indicator of at least one respondent response to at least one question in the survey submitted to the host server via the respondent terminal; and
storing the at least one response in an extensible markup language (XML) structure containing the at least one question and its associated properties in the survey results table stored on the host server.

2. The method of claim 1, wherein transmitting the survey to at least one respondent comprises:
searching the host server to determine whether the survey results table exists;
reading the XML structure from the survey results table when the survey exists;
searching the host server to determine whether the at least one respondent has begun the survey;
locating a submission key and loading existing survey data when the at least one respondent has begun the survey;
prepopulating the survey results table with at least one existing response; and transmitting the prepopulated survey results table to the at least one respondent.

3. The method of claim 2, further comprising:
transmitting an error message when the survey does not exist.

4. The method of claim 2, further comprising:
creating a respondent entry and transmitting the survey to the at least one respondent when the at least one respondent has not begun the survey.

5. The method of claim 1, further comprising:
creating at least one survey.

6. The method of claim 5, wherein the creating comprises:
allowing a client to choose at least one question style;
allowing the client to choose question text;
allowing the client to select multiple languages;
allowing the client to choose at least one survey presentation style; and
displaying a survey preview incorporating the at least one question style, the question text, and the at least one survey presentation style.

7. The method of claim 1, further comprising:
publishing the survey on a host server.

8. The method of claim 7, wherein the publishing comprises:
accepting an input indicator of account details incorporating client server type and client server address;
accepting an input indicator of a .htm survey file name selection; and
transmitting a uniform resource locator (URL) indicating the location address of the survey.

9. The method of claim 1, further comprising: notifying potential respondents that the survey is available.

10. The method of claim 9, wherein the notifying comprises:
accepting an input indicator of a mailing list of respondent email addresses;
linking the mailing list to the survey;
allowing a client to select text for a survey notification message;
allowing the client to submit server information for the survey notification message;
indicating that the mailing list, survey notification message, and server information is being processed to distributed the mailing list to respondents.

11. The method of claim 1, further comprising:
accepting an input indicator of at least one request for a survey.

12. The method of claim 1, further comprising:
transmitting the at least one response to a client.

13. The method of claim 1, further comprising:
allowing survey results to be analyzed.

14. A computer program product comprising a computer usable medium having control logic stored therein for providing survey services, comprising:
first computer readable program code means for causing the computer to transmit a survey from an associated survey results table stored in a host server to at least one respondent who accesses the survey via a respondent terminal;
second computer readable program code means for causing the computer to accept at least one respondent response to at least one question in the survey submitted to the host server via the respondent terminal; and
third computer readable program code means for causing the computer to store the at least one response in an XML structure containing the at least one question and its associated properties in the survey results table stored on the host server.

15. The product of claim 14, wherein first computer readable program code means for causing the computer to transmit comprises:
fourth computer readable program code means for causing the computer to search a host server to determine whether the survey results table exists;
fifth computer readable program code means for causing the computer to read the XML structure from the survey results table when the survey exists;
sixth computer readable program code means for causing the computer to search the host server to determine whether the at least one respondent has begun the survey;
seventh computer readable program code means for causing the computer to locate a submission key and loading existing survey data when the at least one respondent has begun the survey;
eighth computer readable program means for causing the computer to prepopulate the survey with at least one existing response; and
ninth computer readable program means for causing the computer to transmit the prepopulated survey to the at least one respondent.

16. A computer-implemented system for providing survey services, comprising:
means for transmitting the survey from an associated survey results table stored on a host server to at least one respondent who accesses the survey via a respondent terminal;
means for accepting an input indicator of at least one respondent response to at least one question in the survey submitted to the host server via the respondent terminal; and
means for storing the at least one response in an XML structure containing the at least one question and its associated properties in the survey results table stored on the host server.

17. The computer-implemented system of claim 16, wherein the means for transmitting comprises:
means for searching a host server to determine whether the survey results table exists;
means for reading the XML structure from the host server when the survey results table exists;
means for searching the host server to determine whether the at least one respondent has begun the survey;
means for locating a submission key and loading existing survey data when the at least one respondent has begun the survey;
means for prepopulating the survey with at least one existing response; and
means for transmitting the prepopulated survey to the at least one respondent.
